(19) United States
(12) Patent Application Publication
(10) Pub. No.: US 2016/0246927 A1
(43) Pub. Date: Aug. 25, 2016

(54) HEALTH MANAGEMENT DEVICE, HEALTH MANAGEMENT SYSTEM, AND NOTIFICATION METHOD

(71) Applicant: Panasonic Intellectual Property Management Co., Ltd., Osaka (JP)

(72) Inventor: Shingo TSUKIHARA, Osaka (JP)

(21) Appl. No.: 15/048,272

(22) Filed: Feb. 19, 2016

(30) Foreign Application Priority Data
Feb. 23, 2015 (JP) 2015-032426
Feb. 4, 2016 (JP) 2016-019855

(51) Int. Cl. G06F 19/00; H04L 12/58

(52) U.S. Cl. CPC G06F 19/325; H04L 51/32; G06F 19/322; G06Q 50/22

(57) ABSTRACT

There is provided a health management system capable of easily setting a user who is familiar to a target user as a comparison target of the target user and enhancing health management motivation of the target user. The health management system configured to perform health management of a predetermined target user includes a server configured to transmit vital data of the target user to an SNS server and generate notification information from group post data received from the SNS server, and the SNS server configured to store the group post data. The group post data is data related to the target user.

### BACKGROUND

1. Field

The present disclosure relates to a health management device using vital data, a health management system, and a notification method.

2. Description of Related Art

Conventionally, a health management system has been devised for storing vital data such as blood pressure measured by a target user. A conventional health management system includes a system configured to present to the target user information on health relating to the target user to enhance health management motivation of the target user.

Unexamined Japanese Patent Publication No. 2002-245178 discloses a technique of presenting to the target user ranking data obtained by comparing the target user and the other users who join the same health management service in which the target user joins. Thus, the target user can be compared with the other users.

### SUMMARY

A health management device in the present disclosure is a health management device connected to an SNS server, a first terminal, and a second terminal, and the health management device includes: a vital data receiver configured to receive predetermined vital data from the first terminal; a vital post data transmitter configured to generate vital post data including the vital data, for transmitting the generated vital post data to the SNS server; a group post data receiver configured to receive from the SNS server group post data that includes the vital post data including the vital data, and post data from a user who utilizes the second terminal associated with a user who utilizes the first terminal in the SNS server; a post data extractor configured to extract from the group post data at least one of the vital post data including the vital data, and the post data from the user who utilizes the second terminal; a notification information generator configured to generate notification information, based on the post data extracted by the post data extractor; and a notification information transmitter configured to transmit the notification information to the first terminal.

In addition, a health management system in the present disclosure is a health management system including: an SNS server; a first terminal; a second terminal; and a health management device, and the SNS server includes a group information memory configured to store group information set for each user who utilizes the first terminal, a post data receiver configured to receive post data from the first terminal, and a post data memory configured to store the post data.

The first terminal includes a vital data transmitter configured to transmit vital data. The health management device includes: a vital data receiver configured to receive the vital data from the first terminal; a vital post data transmitter configured to generate vital post data including the vital data, for transmitting the generated vital post data to the SNS server; a group post data receiver configured to receive from the SNS server group post data that includes the vital post data including the vital data, and post data from a user who utilizes the second terminal associated with the user who utilizes the first terminal in the SNS server; a post data extractor configured to extract from the group post data at least one of the vital post data including the vital data, and the post data from the user who utilizes the second terminal; a notification information generator configured to generate notification information, based on the post data extracted by the post data extractor; and a notification information transmitter configured to transmit the notification information to the first terminal.

In addition, a notification method in the present disclosure is a notification method in a health management device connected to an SNS server, a first terminal, and a second terminal, and the notification method includes: receiving predetermined vital data from the first terminal; generating vital post data including the vital data, for transmitting the generated vital post data to the SNS server; receiving from the SNS server group post data that includes the vital post data including the vital data, and the post data from a user who utilizes the second terminal associated with a user who utilizes the first terminal in the SNS server; extracting from the group post data at least one of the vital post data including the vital data, and the post data from the user who utilizes the second terminal; generating notification information, based on the post data extracted in the extracting; and transmitting the notification information to the first terminal.

Thus, it is possible to easily set a user who is familiar to a target user as a comparison target of the target user to enhance health management motivation of the target user.

### BRIEF DESCRIPTION OF DRAWINGS

FIG. 1 is a system configuration diagram illustrating a hardware configuration of a health management system according to a first exemplary embodiment;

FIG. 2 is a schematic diagram illustrating a concept of a group according to a conventional technique;

FIG. 3 is a schematic diagram illustrating a concept of a group according to the first exemplary embodiment;

FIG. 4 is a block diagram illustrating a functional configuration of the health management system according to the first exemplary embodiment;

FIG. 5 is an operation flow diagram for describing operation of vital post data transmission according to the first exemplary embodiment;

FIG. 6 is an operation flow diagram for describing operation of notification information transmission according to the first exemplary embodiment;

FIG. 7 is an operation flow diagram for describing operation of health status determination according to the first exemplary embodiment;

FIG. 8 is an operation flow diagram for describing operation of notification post data transmission according to the first exemplary embodiment;

FIG. 9 is a schematic diagram for describing an image of statistics information and ranking information according to the first exemplary embodiment; and

FIG. 10 is a schematic diagram for describing an image of support post data according to the first exemplary embodiment.

### DETAILED DESCRIPTION

Exemplary embodiments are described in detail below with appropriate reference to drawings. However, an unnecessarily detailed description may be omitted. For example, a detailed description of an already well known matter and a duplicate description for substantially the same configuration may be omitted. This is to avoid the description below is unnecessarily redundant, and to facilitate understanding of those skilled in the art.

Incidentally, accompanying drawings and the description below are provided so that those skilled in the art sufficiently understand the present disclosure, and are not intended to limit the claimed subject matter.

### First Exemplary Embodiment

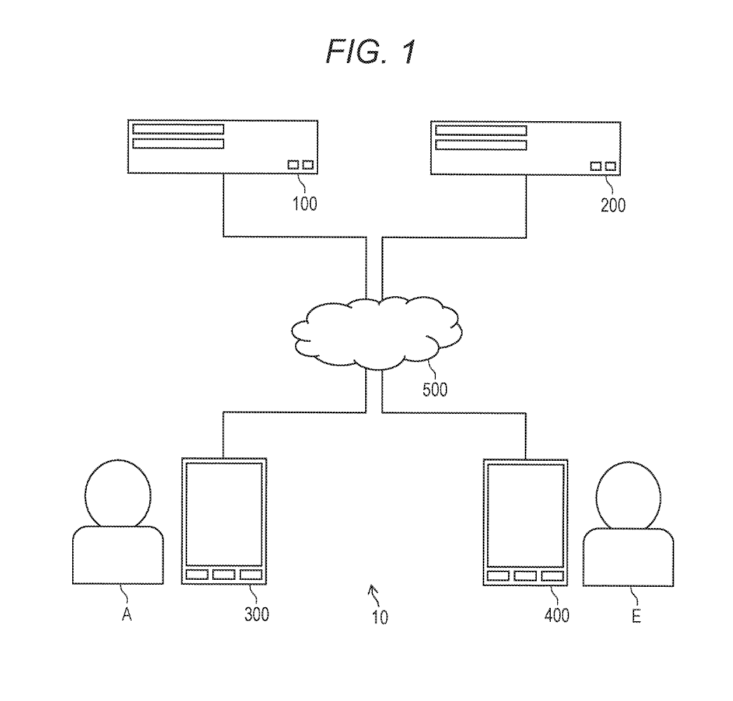

A first exemplary embodiment is described below with reference to FIGS. 1 to 10.

[1-1. Configuration]

[1-1-1. System Configuration]

FIG. 1 is a system configuration diagram illustrating a hardware configuration of health management system 10 according to the first exemplary embodiment. Health management system 10 includes a health management device, a social networking service (hereinafter referred to as an SNS) server, and a plurality of terminals.

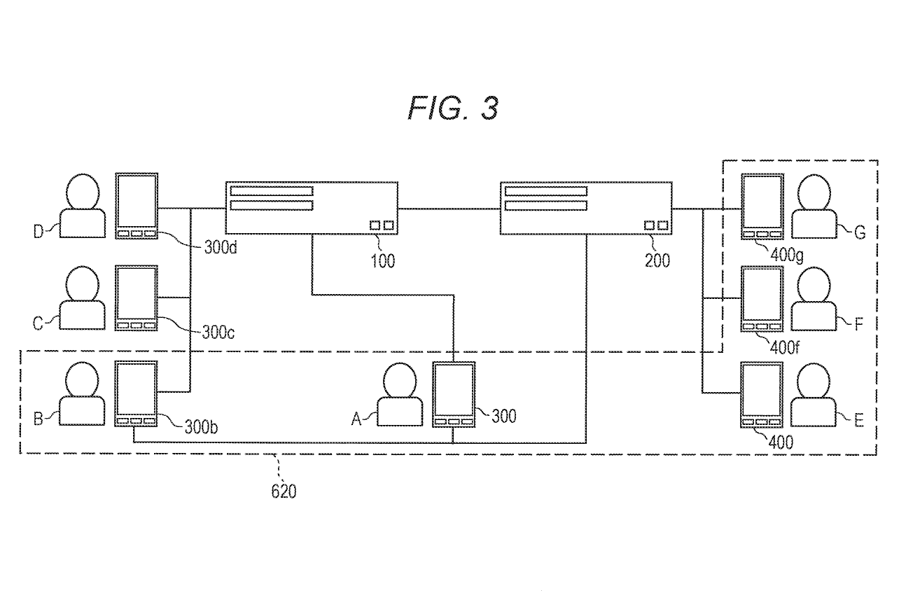

Server 100 is one example of the health management device, and provides a health management service. SNS server 200 is one example of the SNS server, and provides the SNS. User terminal 300 (first terminal) is one example of the terminal with which the health management service is utilized. SNS user terminal 400 (second terminal) is one example of the terminal with which the SNS is utilized. For the terminal, the first terminal may serve as SNS user terminal 400, and the second terminal may serve as user terminal 300, and a number of terminals is not limited, so that there may be a third terminal (for example, user terminal 300b illustrated in FIG. 3) and a fourth terminal (for example, SNS user terminal 400f illustrated in FIG. 3). User terminal 300 is connected to server 100 via Internet line network 500, and SNS user terminal 400 is connected to SNS server 200 via Internet line network 500.

The SNS is a service that constructs a social network on the Internet, and aims to facilitate and support connections among people. The SNS includes a communication service having a function of allowing users to form a group and exchange information mutually in the group, and a communication service having a function of allowing a target user to be presented with comments to the target user and comments to the comment of the target user. Incidentally, specific examples of the SNS include a blog, an electronic bulletin board, Facebook (registered trademark), LINE (registered trademark), Twitter (registered trademark), but are not limited thereto.

In health management system 10, the SNS having a function of allowing users to form a group is described as an example.

In FIG. 1, users A, E are described as examples, and other users are omitted in FIG. 1 since they are the same as users A, E when the service to join is the same. Users A, B join the health management service and the SNS, and user B is a related person when viewed from user A. Users C, D join the health management service, but are not users related when viewed from user A (persons who are not familiar to user A, that is, strangers). Users E, F, G join the SNS, and are related persons when viewed from user A.

User A inputs daily vital data to user terminal 300. The vital data input to user terminal 300 is transmitted to server 100 via Internet line network 500.

The vital data is configured from a measurement value (including an increment and a decrement) of a vital item to serve as an index of a health status, for example, a blood pressure, body weight, body fat percentage, body temperature, skin condition, number of steps, or blood glucose level, and information such as a user label, a vital item label, a date and time of measurement. The user label is identification information for specifying a user, and based on the label, server 100 searches a specific user. The vital item label is information for specifying the vital item indicative of the health condition of the user. The server 100 performs a search for the vital item based on the vital item label. Specifically, when user A inputs a body weight of 60.0 kg measured at 10:00 Jan. 27, 2015, vital data of “user label: A′, vital item label: body weight, measurement value: 60.0, date and time of measurement: 10:00 Jan. 27, 2015” is transmitted to server 100. User label A′ is the user label of user A registered with the health management service.

Server 100 stores the vital data received from user terminal 300, and generates from the received vital data vital post data according to a predetermined vital post format. The vital post format is a format for converting the vital item label, measurement value, date and time of measurement included in the vital data to a predetermined character string, and providing a character string to serve as an identifier for extracting the vital post data from group post data by a post data extractor.

Specifically, server 100 performs character string conversion of the vital item label to “[vital item label]‘is,’” and performs character string conversion of the measurement value, when it is a body weight, to “[measurement value]‘kg.’”, and divides the date and time of measurement into a measurement month, measurement day, measurement time, measurement minute, and then performs character string conversion to “[measurement month]‘/’ [measurement day]‘ ’ [measurement time]‘:’ [measurement minute],” and provides a character string of an extraction identifier “‘#health management service’.” When server 100, according to this format, converts the vital data of “user label: A′, vital item label: body weight, measurement value: 60.0, date and time of measurement: 10:00 Jan. 27, 2015,” the vital post data is generated of “‘body weight is 60.0 kg. date and time of measurement: 01/07 10:00 #health management service’.” In addition, server 100 performs character string conversion of the measurement value, when vital item label is a number of steps, to “[measurement value]‘steps.’” The vital post data is generated of “‘number of steps is 10,000 steps, date and time of measurement: 01/27 20:00 #health management service’.” The vital post format may include a character string indicating an aimed value to serve as an aim of the measurement value set in advance by user A to any vital item, and a difference from the measurement value, and may include a character string of a comment that prompts posting to the SNS to members in an SNS group of user A. Incidentally, the vital post format varies for each vital item. The vital post data is transmitted to SNS server 200 via Internet line network 500 from server 100, with SNS access token A corresponding to user label A′ of the vital data.

The SNS access token is an access token for server 100 to obtain authority of the user on the SNS. Server 100, when transmitting post data of user A to SNS server 200 or receiving the post data of a group of user A from SNS server 200, exchanges user label A′ for corresponding SNS access token A in server 100. SNS access token A corresponds to user label A′, user label A″ one to one. User label A″ is a user label of user A registered with the SNS. Incidentally, when the user is user B, SNS access token B corresponds to user label B′, user label B″ one to one. Server 100 transmits SNS access token A exchanged to SNS server 200, with a registration request of the post data of user A or an acquisition request of the post data of the group of user A. SNS server 200 exchanges SNS access token A received for user label A″, and performs storing of the post data of user A or searching for the post data of the group of user A. The post data of user A is post data to the SNS of user A, and is associated with user label A″ of user A registered with the SNS. In addition, the post data of the group of user A is data posted to the SNS by the member (for example, user E) in the group of user A, and is associated with user label E″ of user E registered with the SNS.

Here, an issuance procedure of the SNS access token is described. The SNS access token is issued by pre-authentication between server 100 and SNS server 200, based on permission of the user terminal, and is stored by server 100. The issuance of the SNS access token is performed by, for example, a method of OAuth authentication.

Specifically, when user A attempts SNS authentication on a screen of user terminal 300, user terminal 300 transmits a request for the SNS authentication to server 100 via Internet line network 500. Server 100, when receiving the request for the SNS authentication, transmits an SNS request token reception request (a reception request of a token to serve as a base of a URL for allowing user terminal 300 to perform the SNS authentication) and a callback URL (a URL of server 100 transmitted by SNS server 200 after user terminal 300 performs the SNS authentication) to SNS server 200 via Internet line network 500.

SNS server 200, when receiving the SNS request token reception request, transmits an SNS request token to server 100 via Internet line network 500.

Server 100, based on the SNS request token received, generates an SNS authentication page URL (a URL of an SNS authentication page provided by SNS server 200). Server 100 transmits the SNS authentication page URL generated to user terminal 300 via Internet line network 500.

User terminal 300 opens the SNS authentication page URL received with a browser to display the same on the screen. User A performs the SNS authentication from the SNS authentication page displayed in user terminal 300.

When the SNS authentication is completed, SNS server 200 returns the callback URL received in advance from server 100 to the browser of user terminal 300.

When the browser of user terminal 300 opens the callback URL, server 100 receives SNS authentication completion notification of user A.

Server 100, when receiving the SNS authentication completion notification of user A, transmits an SNS access token A reception request corresponding to user label A′ to SNS server 200 via Internet line network 500.

SNS server 200, when receiving the SNS access token A reception request, issues SNS access token A corresponding to user label A″ to transmit the same to server 100 via Internet line network 500.

Server 100 stores SNS access token A received in association with user label A′.

SNS server 200 stores the post data and group information on the SNS.

The post data is data posted on the SNS, and is associated with the user label of the user registered with the SNS.

The group information is group information on the SNS, and is configured from the user label of the user registered with the SNS, and the user label of another user relating to the user on the SNS.

SNS server 200, based on SNS access token A received, associates the vital post data received with user label A″ to store the same as the post data. Incidentally, SNS server 200 stores the vital post data and normal post data without distinguishing from each other.

User E acquires or registers the post data on the SNS by using SNS user terminal 400.

When user A displays notification information on user terminal 300, user terminal 300 transmits a reception request of the notification information to user A to server 100 via Internet line network 500.

Server 100, when receiving the reception request of the notification information to user A, transmits a reception request of the group post data of user A to SNS server 200 via Internet line network 500, with SNS access token A corresponding to user label A′.

SNS server 200, when receiving the reception request of the group post data of user A, based on SNS access token A received, transmits the post data of the group to which user A belongs to server 100 via Internet line network 500.

Server 100, after receiving the post data of the group of user A, generates the notification information to user A, for transmitting the same to user terminal 300 via Internet line network 500.

The notification information is information configured by at least one of a support comment, statistics information, and ranking information.

The support comment is a comment for supporting health management to the user who joins the health management service. The support comment includes comments of supporting and encouraging, for example, lost weight, diet success, light, lost, good, good value, go for it, great, good condition, good luck, never mind. In the present exemplary embodiment, the support comment is, for example, support post data extracted from reply post data by context analysis.

The reply post data is post data replied to the post data registered with the SNS by the target user from the user who belongs to the same group on the SNS (a user who utilizes another terminal).

The support post data is post data for supporting the health management, in which the reply post data to the vital post data of the target user is extracted from the reply post data.

The statistics information is information of statistics based on the vital data of the group to which the user who joins the health management service belongs. In the present exemplary embodiment, the statistics information is statistics information of the group, such as a maximum value, minimum value, average value of any vital item, period, which is calculated from the vital post data of users who belong to the same group on the SNS.

The ranking information is information of ranking of each of the users based on the vital data of the group to which the user who joins the health management service belongs. In the present exemplary embodiment, the ranking information is ranking information of each of the users in the group of any vital item, period, which is calculated from the vital post data of the users who belong to the same group on the SNS.

Incidentally, the vital post data used by server 100 for generating the notification information, if it is in accordance with a predetermined vital post format, is not limited to the vital post data transmitted by server 100. The vital post data may be, for example, data transmitted from another server other than server 100 connected to SNS server 200, or SNS user terminal 400.

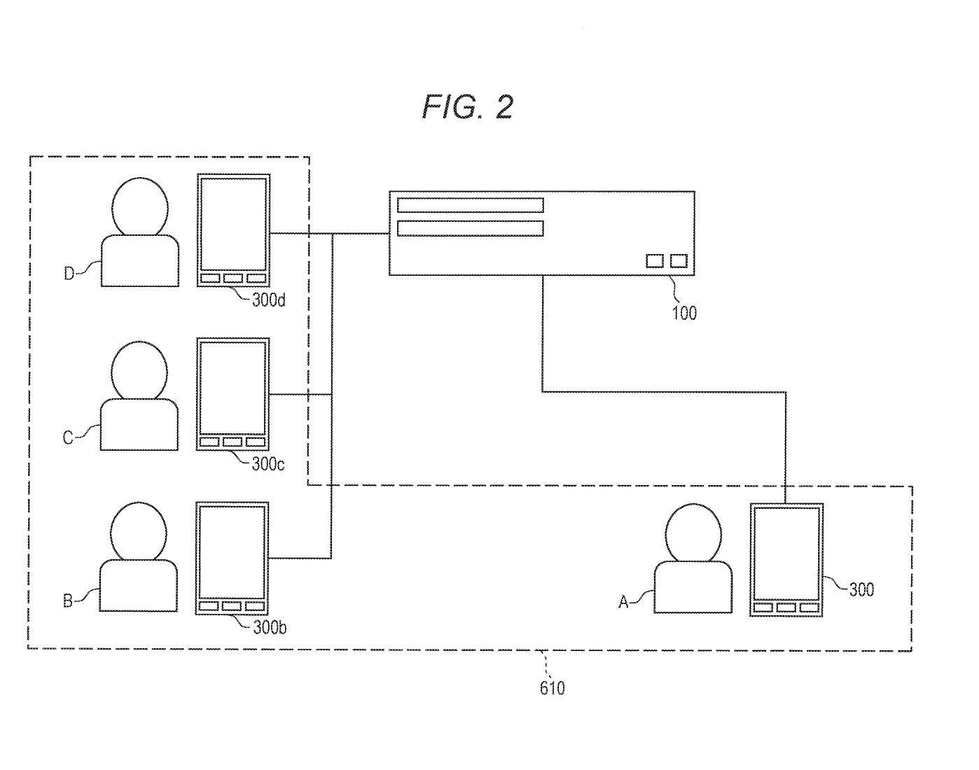

A concept is described of a group to serve as an acquisition range of the data used for generating the notification information in the present exemplary embodiment. FIG. 2 is a schematic diagram illustrating a concept of a group in a conventional technique, and FIG. 3 is a schematic diagram illustrating a concept of a group in the present exemplary embodiment.

In FIG. 2, users A, B, C, D are users who join the health management service. A range of the group configured by users A, B, C, D prepared on the health management service is as indicated by health management service group 610 (see enclosing dashed line in FIG. 2).

User B is a user related to user A, and users C, D are not users related to user A. For example, when taking statistics information, even if server 100 provides the notification information to user A from health management service group 610, the statistics information includes that of the users not related. Therefore, user A is not motivated when viewing the notification information (statistics information), so that effect is small of motivation enhancement in the health management for user A.

However, it takes time and labor for user A to prepare a group configured by users A, B. In addition, when not joining the health management service, users E, F, G cannot be included in the group who are users related to user A.

On the other hand, in the present exemplary embodiment, a group on the SNS is utilized as illustrated in FIG. 3. In FIG. 3, users A, B are users who join the health management service and the SNS. Users C, D are users who join only the health management service. Users E, F, G are users who join only the SNS. A range of a group configured by users A, B, E, F, G on the SNS is as indicated by SNS group 620 (see enclosing dashed line in FIG. 3). The users configuring SNS group 620 are users related to user A. By utilizing SNS group 620, it is possible to exclude users C, D who are not related to user A from the group without time and labor.

Further, by utilizing SNS group 620, it is possible to include users E, F, G who do not join the health management service in the group. By providing the support comment, statistics information, ranking information of SNS group 620 configured by the users related to user A, it is possible to increase effect of enhancing motivation of the health management of user A.

Server 100 generates notification post data from the notification information generated for user A, at any timing. The notification post data is transmitted to SNS server 200 via Internet line network 500 from server 100, with SNS access token A corresponding to user A.

[1-1-2. Function Block]

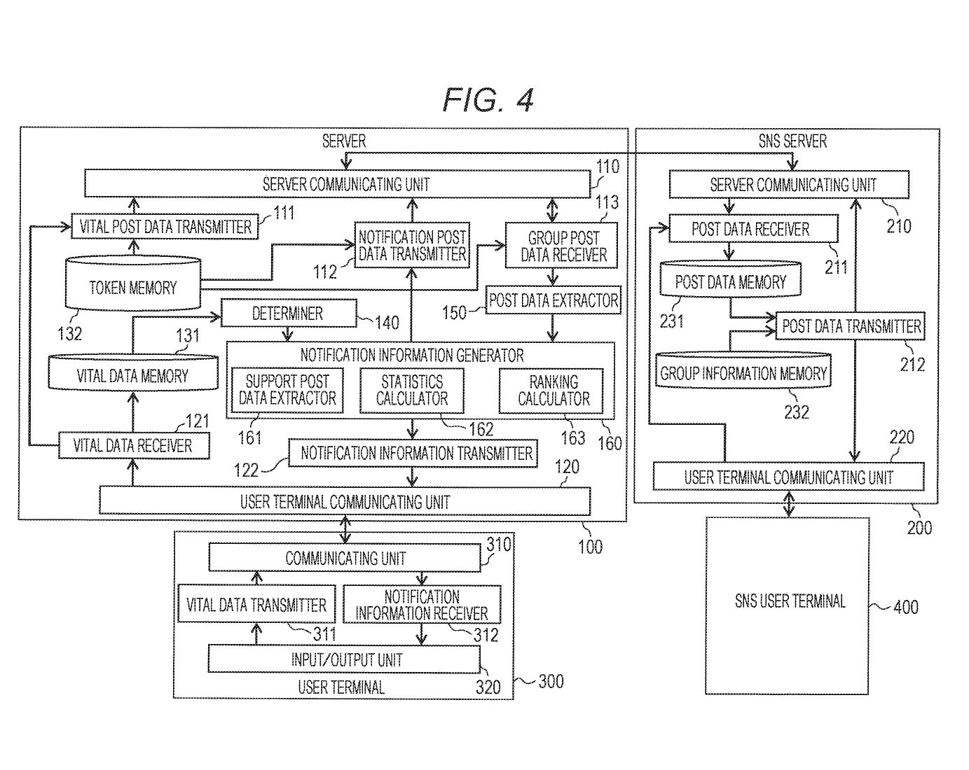

FIG. 4 is a block diagram illustrating a functional configuration of health management system 10 according to the first exemplary embodiment.

Server 100 has server communicating unit 110, vital post data transmitter 111, notification post data transmitter 112, group post data receiver 113, user terminal communicating unit 120, vital data receiver 121, user terminal notification information transmitter 122, vital data memory 131, token memory 132, determiner 140, post data extractor 150, and notification information generator 160.

Server communicating unit 110 communicates with SNS server 200. Vital post data transmitter 111 transmits vital post data to SNS server 200 via server communicating unit 110. Notification post data transmitter 112 transmits notification post data to SNS server 200 via server communicating unit 110. Group post data receiver 113 receives the post data of the group on the SNS from SNS server 200 via server communicating unit 110. User terminal communicating unit 120 communicates with user terminal 300. Vital data receiver 121 receives vital data from user terminal 300 via user terminal communicating unit 120. Notification information transmitter 122 transmits notification information to user terminal 300 via user terminal communicating unit 120. Vital data memory 131 stores the vital data received from vital data receiver 121. Token memory 132 stores an SNS access token. Determiner 140 determines the health status of the user, based on the vital data received from vital data memory 131. Post data extractor 150 extracts post data having a predetermined characteristic from the group post data received from group post data receiver 113. Notification information generator 160 generates the notification information, based on a health status determination result received from determiner 140 and the post data received from post data extractor 150.

Notification information generator 160 has support post data extractor 161 configured to extract support post data, statistics calculator 162 configured to calculate statistics information, and ranking calculator 163 configured to calculate ranking information.

Vital post data transmitter 111 generates the vital post data according to a predetermined vital post format from the vital data received from vital data receiver 121. Vital post data transmitter 111 receives from token memory 132 the SNS access token corresponding to the user who transmits the vital post data, and transmits to SNS server 200 the vital post data generated, with the SNS access token.

Notification post data transmitter 112 generates the notification post data from the notification information received from notification information generator 160. Notification post data transmitter 112 receives from token memory 132 the SNS access token corresponding to the user who transmits the notification post data, and transmits to SNS server 200 the notification post data generated, with the SNS access token.

Group post data receiver 113 receives from token memory 132 the SNS access token corresponding to the user receiving the group post data. Group post data receiver 113 transmits to SNS server 200 a reception request of the group post data of the user registered with the SNS corresponding to the SNS access token received, and receives the group post data from SNS server 200.

Determiner 140 receives from vital data memory 131 the vital data of any user, vital item, period, and determines the health status of the user, and then transmits the result as a determination result to notification information generator 160. In the present exemplary embodiment, the determination result is any one of improved, stable, deteriorated.

Post data extractor 150 receives the group post data from group post data receiver 113, and extracts the post data having the predetermined characteristic from the group post data received. The post data extracted is transmitted to notification information generator 160. Specifically, when extraction of the support post data is performed by notification information generator 160, post data extractor 150 extracts from the group post data the vital post data of the target user of any vital item, period, and the reply post data to the target user of any period. When calculation of statistics information or calculation of ranking information is performed by notification information generator 160, post data extractor 150 extracts from the group post data the vital post data of any vital item, period.

Support post data extractor 161 extracts the support post data to the target user, based on the post data received from post data extractor 150. Specifically, support post data extractor 161 receives from post data extractor 150 the vital post data of the target user of any vital item, period, and the reply post data to the target user of any period. Support post data extractor 161 extracts from the reply post data received the post data as the support post data to the vital post data of the target user of any vital item, period. Support post data extractor 161 may extract the support post data according to the health status of the target user, based on the determination result of the health status of the target user received from determiner 140. Specifically, when the determination result of the target user is improved, the support post data for praising the target user may be extracted, and when the determination result is deteriorated, the support post data for reproving the target user may be extracted.

Statistics calculator 162 calculates statistics information, such as a maximum value, minimum value, average value of the vital data of any vital item, period of the target group, based on the vital post data of any vital item, period received from post data extractor 150. Statistics calculator 162 may provide the calculated statistics information with information based on the determination result of the health status of the target user received from determiner 140. Specifically, a comment may be provided which is prepared based on a comparison between the statistics information of the target group and the determination result of the health status of the target user with each other.

Ranking calculator 163 calculates ranking information in the target group of the vital data of any vital item, period of the target user, based on the vital post data of any vital item, period received from post data extractor 150. Ranking calculator 163 may provide the calculated ranking information with information based on the determination result of the health status of the target user received from determiner 140. Specifically, when the user is ranked higher than the middle and the determination result is improved, a comment may be provided for praising the target user. When the user is ranked lower than the middle and the determination result is deteriorated, a comment may be provided for reproving the target user. When the user is ranked higher than the middle and the determination result is deteriorated, a comment may be provided for pointing out a poor health status of the group while praising the target user. When the user is ranked lower than the middle and the determination result is improved, a comment may be provided for pointing out a good health status of the group while reproving the target user.

SNS server 200 has server communicating unit 210, post data receiver 211, server post data transmitter 212, user terminal communicating unit 220, post data memory 231, and group information memory 232.

Server communicating unit 210 communicates with server 100. Post data receiver 211 receives the post data from server 100 via server communicating unit 210, or from SNS user terminal 400 via SNS user terminal communicating unit 220. Post data transmitter 212 transmits the post data to server 100 via server communicating unit 210, or to SNS user terminal 400 via SNS user terminal communicating unit 220. User terminal communicating unit 220 communicates with SNS user terminal 400. Post data memory 231 stores the post data on the SNS. Group information memory 232 stores the group information on the SNS.

Post data transmitter 212 transmits the post data to server 100 or SNS user terminal 400. Post data transmitter 212, when receiving the reception request of the group post data from server 100, receives SNS group information of the target user from SNS group information memory 232. Post data transmitter 212 receives from post data memory 231 the post data of the user included in the SNS group information received, and transmits the post data as the group post data to server 100 via server communicating unit 210.

User terminal 300 has communicating unit 310, vital data transmitter 311, server notification information receiver 312, and input/output unit 320.

Communicating unit 310 communicates with server 100. Vital data transmitter 311 transmits the vital data input by the user to server 100 via communicating unit 310. Notification information receiver 312 receives the notification information from server 100 via communicating unit 310.

Input/output unit 320 receives an input of the vital data of the user, and displays the notification information to the user.

[1-2. Operation]

Operation of health management system 10 configured as described above is described below.

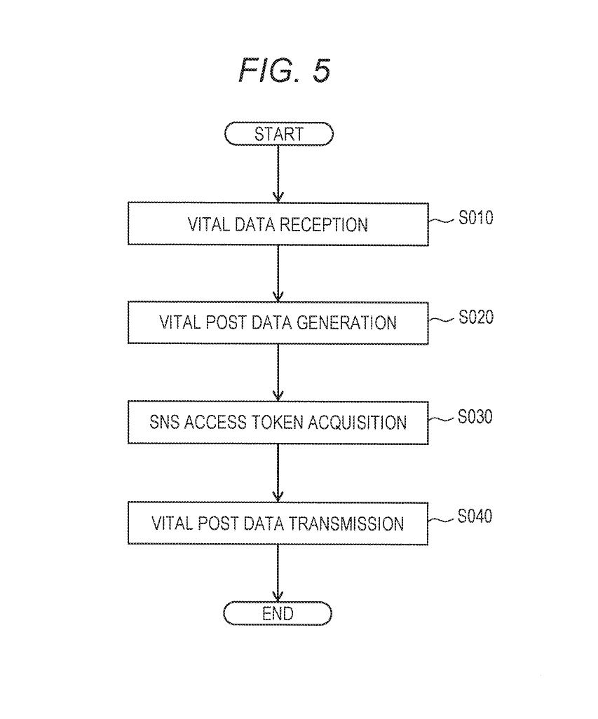

FIG. 5 is a flowchart for describing operation of vital post data transmission by server 100 in health management system 10 according to the first exemplary embodiment.

When receiving a start instruction from server 100 in response to a transmission request of the vital data from user terminal 300, vital data receiver 121 receives the vital data of the target user from user terminal 300 via user terminal communicating unit 120 (S010). Vital post data transmitter 111 receives the vital data from vital data receiver 121 to generate the vital post data (S020). Vital post data transmitter 111 acquires the SNS access token of the target user from token memory 132. (S030). Vital post data transmitter 111 transmits the vital post data generated to the SNS server via server communicating unit 110, with the SNS access token (S040). Thus, the operation of the vital post data transmission by server 100 is ended.

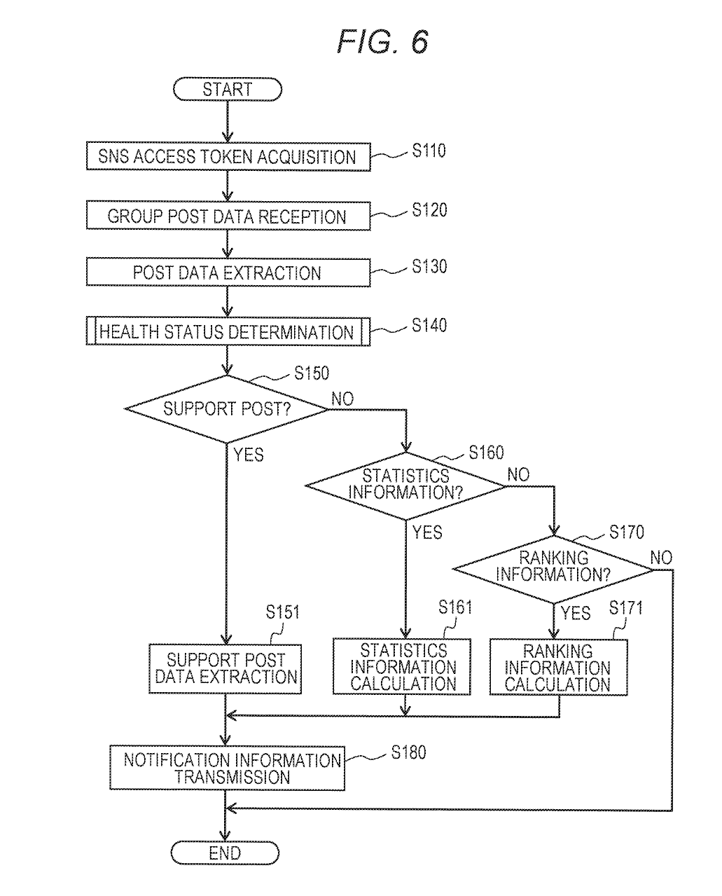

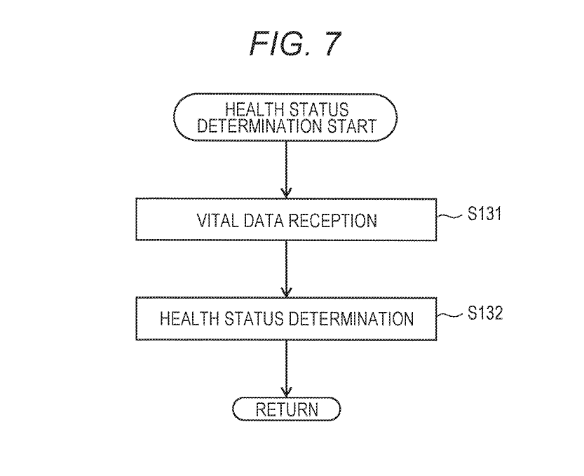

FIG. 6, FIG. 7 are flowcharts for describing operation of notification information transmission by server 100 in health management system 10 according to the first exemplary embodiment.

When receiving a start instruction from server 100 in response to a reception request of the notification information from user terminal 300, group post data receiver 113 receives the SNS access token of the target user from token memory 132 (S110). Group post data receiver 113 receives the group post data of the target user from SNS server 200 via server communicating unit 110 (S120). Post data extractor 150 receives the group post data from group post data receiver 113 to extract the post data having the predetermined characteristic (S130). Determiner 140 determines the health status of the target user (S140). In detail, as illustrated in FIG. 7, when the determination of the health status is started, determiner 140 receives the vital data from vital data memory 131 (S131). Determiner 140, based on the vital data received, determines the health status of the target user (S132).

Referring back to FIG. 6, notification information generator 160 receives the post data from post data extractor 150, and receives the determination result of the target user from determiner 140, and determines whether or not the reception request of the notification information from user terminal 300 is a support post (S150). When the reception request is the support post (S150: YES), notification information generator 160 extracts the support post data of the target user, based on the determination result of the target user, and transmits the support post data as the notification information to notification information transmitter 122 (S151). When the reception request is not the support post (S150: NO), notification information generator 160 determines whether or not the reception request is statistics information (S160). When the reception request is the statistics information (S160: YES), notification information generator 160 calculates the statistics information of the target group, based on the determination result of the target user, and transmits the statistics data as the notification information to notification information transmitter 122 (S161). When the reception request is not the statistics information (8160: NO), notification information generator 160 determines whether or not the reception request is ranking information (S170). When the reception request is the ranking information (S170: YES), notification information generator 160 calculates the ranking information in the target group of the target user, based on the determination result of the target user, and transmits the ranking information as the notification information to notification information transmitter 122 (8171). When the reception request is not the ranking information (S170: NO), notification information generator 160 ends the processing. Notification information transmitter 122 receives the notification information from notification information generator 160, and transmits the notification information to user terminal 300 via user terminal communicating unit 120 (S180). Thus, the operation of the notification information transmission by server 100 is ended.

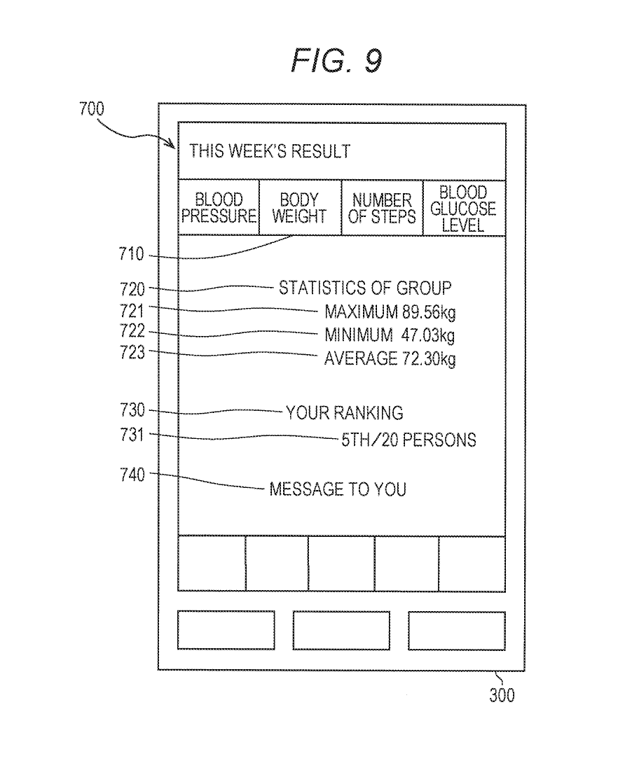

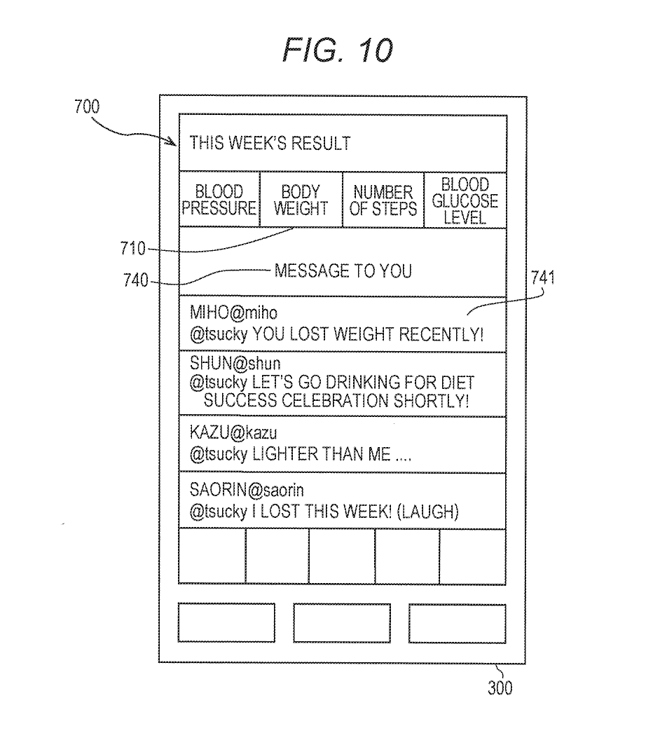

FIG. 9, FIG. 10 are examples of the notification information displayed in input/output unit 320 in user terminal 300.

Notification information display screen 700 is configured by selection tab 710 with which the target user can select the vital item of the notification information displayed by tap operation, statistics display area 720 for displaying the statistics information, ranking display area 730 for displaying the ranking information, and support post data display area 740 for displaying the support post data. Statistics display area 720 is configured by maximum value display section 721 for indicating a maximum value of the vital data of the target group, minimum value display section 722 for indicating a minimum value of the vital data of the target group, and average value display section 723 for indicating an average value of the vital data of the target group. Ranking display area 730 is configured by ranking display section 731 for indicating ranking in the target group of the target user. Support post data display area 740 is configured by support post data display section 741 (see FIG. 10) for displaying the support post data to the target user. Notification information display screen 700 scrolls in a screen vertical direction by swipe operation of the target user, and displays the area ranging from statistics display area 720 and ranking display area 730 in FIG. 9 to support post data display area 740 in FIG. 10. As illustrated in FIG. 10, the support post data is a comment posted on the SNS, for example, you lost weight recently!, let's go drinking for diet success celebration shortly, lighter than me, I lost this week!However, the support post data is not particularly limited as far as it is a comment for supporting the health management to the target user.

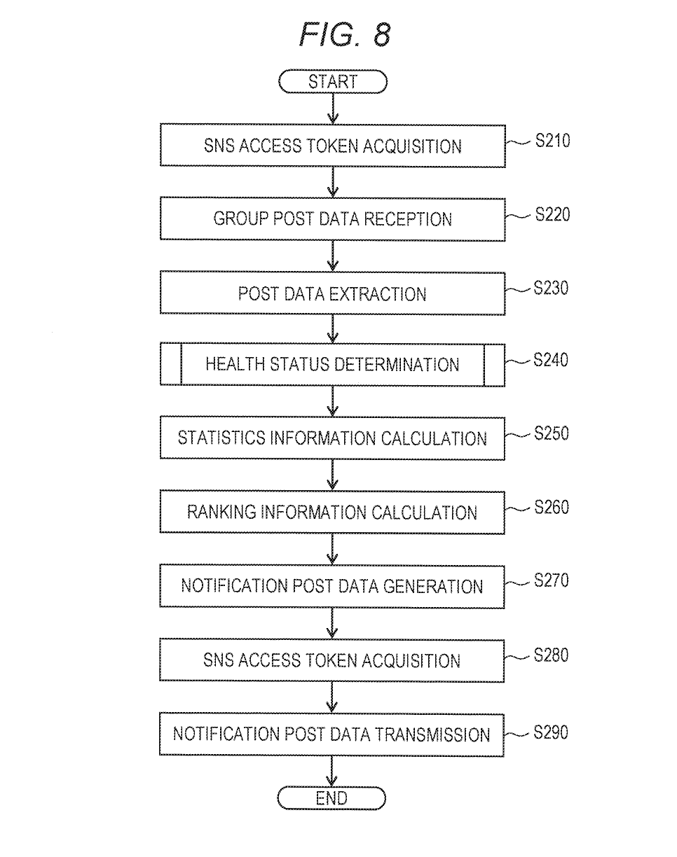

FIG. 7, FIG. 8 are flowcharts for describing the operation of notification post data transmission by server 100 in health management system 10 according to the first exemplary embodiment.

When receiving a start instruction from server 100 at any timing, group post data receiver 113 receives the SNS access token of the target user from token memory 132 (S210). Group post data receiver 113 receives the group post data of the target user from SNS server 200 via server communicating unit 110 (S220). Post data extractor 150 receives the group post data from group post data receiver 113 to extract the post data having the predetermined characteristic (S230). Determiner 140 determines the health status of the target user (S240). In detail, as illustrated in FIG. 7, when the determination of the health status is started, determiner 140 receives the vital data from vital data memory 131 (S131). Determiner 140, based on the vital data received, determines the health status of the target user (S132).

Referring back to FIG. 8, notification information generator 160 receives the post data from post data extractor 150, and receives the determination result of the target user from determiner 140. Notification information generator 160 calculates the statistics information of the target group, based on the determination result of the target user, and transmits the statistics information as the notification information to notification post data transmitter 112 (S250). Notification information generator 160 calculates the ranking information in the target group of the target user, based on the determination result of the target user, and transmits the ranking information as the notification information to notification post data transmitter 112 (S260). Notification post data transmitter 112 receives the notification information from notification information generator 160 to generate the notification post data (S270). Notification post data transmitter 112 receives the SNS access token of the target user from token memory 132 (S280). Notification post data transmitter 112 transmits the notification post data generated to SNS server via server communicating unit 110, with the SNS access token (S290). Thus, the operation of the notification post data transmission by server 100 is ended.

[1-3. Effects]

As described above, in the present exemplary embodiment, health management system 10 has server 100, SNS server 200, server user terminal 300, and SNS user terminal 400.

Server 100 transmits the vital data of user A to SNS server 200, and generates the notification information from the group post data received from SNS server 200. SNS server 200 stores the post data. User terminal 300 presents the notification information received from server 100 to user A. SNS user terminal 400 receives the post data from SNS server 200, and transmits the post data to SNS server 200.

Server 100 has token memory 132, group post data receiver 113, post data extractor 150, notification information generator 160, and user terminal notification information transmitter 122.

Token memory 132 stores the SNS access token for server 100 to obtain the authority of the user on the SNS. Group post data receiver 113 receives the post data of the group on the SNS from SNS server 200. Post data extractor 150 extracts the post data having the predetermined characteristic from the group post data received from group post data receiver 113. Notification information generator 160 generates the notification information, based on the post data received from post data extractor 150. Notification information transmitter 122 transmits the notification information to user terminal 300.

User terminal 300 has notification information receiver 312 configured to receive the notification information from server 100, and input/output unit 320 configured to display the notification information to user A.

Thus, it is possible to present the support comment, statistics information, ranking information of the group configured by the users who are familiar to user A and connected with user A on the SNS, and to enhance health management motivation of user A. Specifically, it is possible to easily prepare the group of the users connected with each other on the SNS on the health management service, and to include an SNS user into the group who does not join the health management service.

### Other Exemplary Embodiment

As described above, as an exemplification of a technique disclosed in the present application, the first exemplary embodiment has been described. However, the technique of the present disclosure is not limited thereto, and it is also possible to apply the technique to an exemplary embodiment in which modification, replacement, addition, omission are appropriately performed. In addition, it is possible to make a new exemplary embodiment by combining elements described in the first exemplary embodiment.

Therefore, another exemplary embodiment is exemplified below.

(A) In the first exemplary embodiment, as one example of input means of the vital data, it has been described on a premise that the vital data is manually input by user A to user terminal 300. The transmission of the daily vital data to server 100 needs to be performed via communicating unit 310 of user terminal 300 and the like but is not limited to the manual input. For example, the vital data may be transmitted to server 100 by a measurement device (sphygmomanometer, weighing machine [including body fat meter], thermometer, pedometer, sleep meter, blood glucose level sensor, skin scope, vascular age measurement device, brain age measurement device) capable of communicating with user terminal 300, a measurement device incorporated in user terminal 300, or a measurement device having a communicating unit.

(B) In the first exemplary embodiment, as statistics information, the statistics information of the group has been assumed, such as a maximum value, minimum value, average value of any vital item, period, calculated from the vital post data of the users who belong to the same group on the SNS. However, the statistics information is not limited to the maximum value, minimum value, average value. For example, the statistics information may be a tendency, such as a median, variance, standard deviation, number of vital post data, rising and falling.

(C) In the first exemplary embodiment, improved, stable, deteriorated have been assumed as the determination result of the health status that is the result of the health status of the user determined by determiner 140. However, the determination result is not limited to improved, stable, deteriorated. For example, the health status may be evaluated in 5 stages of improved, slightly improved, stable, slightly deteriorated, deteriorated. In addition, in consideration of the previous determination result, the health status may be evaluated in 9 stages of improved->improved, improved->stable, improved->deteriorated, stable->improved, stable->stable, stable->deteriorated, deteriorated->improved, deteriorated->stable, deteriorated->deteriorated.

(D) In the first exemplary embodiment, post data transmitter 212, when receiving the reception request of the group post data from server 100, receives the SNS group information of the target user from SNS group information memory 232. The example has been described in which post data transmitter 212 receives from post data memory 231 the post data of the user included in the SNS group information received, and transmits to server 100 the post data as the group post data. At this time, the group post data only needs to be the post data relating to the target user on the SNS. For example, the group post data may be post data posted to the target user on the SNS rather than the data based on the group information defined in advance like the group information.

Incidentally, in each of the exemplary embodiments described above, the elements may be configured by dedicated hardware, or may be implemented by executing a software program suitable for the elements. The elements may be implemented by a program execution unit, such as a CPU or a processor, which reads and executes a software program recorded in a recording medium, such as a hard disk or memory. In addition, each table according to each of the exemplary embodiments described above is included in a storage device such as a memory included in an analysis device.

In health management system 10 in the exemplary embodiments described above, each of function blocks, such as server communicating unit 110, vital post data transmitter 111, notification post data transmitter 112, group post data receiver 113, user terminal communicating unit 120, vital data receiver 121, notification information transmitter 122, vital data memory 131, token memory 132, determiner 140, post data extractor 150, notification information generator 160, may be individually integrated into one chip of a semiconductor device such as an LSI, and may be integrated into one chip to include a part or entire of the function blocks.

A part or entire of processing of each of the function blocks in each of the exemplary embodiments described above may be one implemented by a computer program. In addition, each piece of processing of the exemplary embodiments described above may be implemented by hardware, and may be implemented by software (including a case of being implemented with OS [Operating System], middleware, or a predetermined library). Further, the processing may be implemented by mixed processing of the software and the hardware.

In addition, execution order of the processing method in the exemplary embodiments described above is not necessarily limited to the description of the exemplary embodiments described above, and it is possible to switch the execution order without departing from the scope of the present disclosure.

A processing method executed by health management system 10 described above, and a computer program allowing a computer to execute the processing method and a computer-readable recording medium for recording the program, are included in the scope of the present disclosure. Here, the computer-readable recording medium includes, for example, a flexible disk, hard disk, CD-ROM, MO, DVD, DVD-ROM, DVD-RAM, BD (Blu-ray [registered trademark] Disc), semiconductor memory. The computer program is not limited to ones recorded in the recording medium described above, and may be transmitted through a telecommunication line, wireless or wired communication line, network typified by the Internet, and the like.

The present disclosure can be applied to a health management system aiming to present a target user with information on health of a user relating to the target user on an SNS to enhance health management motivation of the target user.

What is claimed is:

1. A health management device connected to an SNS server, a first terminal and a second terminal, the health management device comprising:
a vital data receiver configured to receive predetermined vital data from the first terminal;
a vital post data transmitter configured to generate vital post data including the vital data, for transmitting the generated vital post data to the SNS server;
a group post data receiver configured to receive from the SNS server group post data that includes the vital post data including the vital data, and post data from a user who utilizes the second terminal associated with a user who utilizes the first terminal in the SNS server;
a post data extractor configured to extract from the group post data at least one of the vital post data including the vital data, and the post data from the user who utilizes the second terminal;
a notification information generator configured to generate notification information based on the post data extracted by the post data extractor; and
a notification information transmitter configured to transmit the notification information to the first terminal.

2. The health management device according to claim 1, further comprising a notification post data transmitter configured to generate post data including the notification information, for transmitting the generated post data to the SNS server.

3. The health management device according to claim 1, comprising a determiner configured to determine a health status of the user who utilizes the first terminal, based on the vital data received by the vital data receiver, wherein the notification information generator generates the notification information, based on a determination result of the determiner and the post data extracted by the post data extractor.

4. The health management device according to claim 1, wherein the notification information is an average value, a maximum value, or a minimum value of the vital data included in the vital post data extracted by the post data extractor.

5. The health management device according to claim 1, wherein the notification information is ranking in a group of the user who utilizes the first terminal in the vital data included in the vital post data extracted by the post data extractor.

6. The health management device according to claim 1, wherein the group post data is post data in a group to which the user who utilizes the first terminal belongs in the SNS server, or post data to the user who utilizes the first terminal in the SNS server.

7. The health management device according to claim 1, wherein the post data extractor extracts the vital post data of a user who utilizes a third terminal different from the first terminal and the second terminal from the post data of the user who utilizes the second terminal.

8. The health management device according to claim 1, further comprising a support post data extractor configured to extract support post data to the user who utilizes the first terminal in the SNS server, based on the vital post data including the vital data received from the post data extractor.

9. A health management system comprising:
an SNS server;
a first terminal;
a second terminal; and
a health management device, wherein
the SNS server includes
a group information memory configured to store group information set for each user who utilizes the first terminal,
a post data receiver configured to receive post data from the first terminal, and
a post data memory configured to store the post data,
the first terminal includes
a vital data transmitter configured to transmit vital data, and
the health management device includes
a vital data receiver configured to receive the vital data from the first terminal,
a vital post data transmitter configured to generate vital post data including the vital data, for transmitting the generated vital post data to the SNS server,
a group post data receiver configured to receive from the SNS server group post data that includes the vital post data including the vital data, and post data from a user who utilizes the second terminal associated with the user who utilizes the first terminal in the SNS server,
a post data extractor configured to extract from the group post data at least one of the vital post data including the vital data, and the post data from the user who utilizes the second terminal,
a notification information generator configured to generate notification information, based on the post data extracted by the post data extractor, and
a notification information transmitter configured to transmit the notification information to the first terminal.

10. A notification method in a health management device connected to an SNS server, a first terminal, and a second terminal, the notification method comprising:
receiving predetermined vital data from the first terminal;
generating vital post data including the vital data, for transmitting the generated vital post data to the SNS server;
receiving from the SNS server group post data that includes the vital post data including the vital data, and post data from a user who utilizes the second terminal associated with a user who utilizes the first terminal in the SNS server;
extracting from the group post data at least one of the vital post data including the vital data, and the post data from the user who utilizes the second terminal;
generating notification information, based on the post data extracted in the extracting; and
transmitting the notification information to the first terminal.
